(19) United States
(12) Patent Application Publication
(10) Pub. No.: US 2026/0327135 A1
(43) Pub. Date: Oct. 22, 2026

(54) POLYMER DISPERSANT COMPOSITIONS AND METHODS OF MAKING AND USING THE SAME

(71) Applicant: ARCLIN USA LLC, Alpharetta, GA (US)

(72) Inventors: Roxanne Dulac, Longueuil (CA); Geneviève Corbeil, Delson (CA); Mario Dupuis, Greenfield Park (CA); Iordana Triantafillu, Brossard (CA)

(73) Assignee: ARCLIN USA LLC, Alpharetta, GA (US)

(21) Appl. No.: 19/646,809

(22) Filed: Apr. 14, 2026

Related U.S. Application Data
(60) Provisional application No. 63/789,717, filed on Apr. 16, 2025.

(51) Int. Cl. C04B 24/16; C04B 14/10; C04B 28/02; C04B 28/14; C04B 103/40; C08F 220/58

(52) U.S. Cl. CPC C04B 24/163; C04B 14/10; C04B 28/02; C04B 28/14; C08F 220/585; C04B 2103/408; C08F 2800/10

(57) ABSTRACT

A polymer dispersant composition is provided. The polymer dispersant composition can include a linear polymer dispersant composition, a branched polymer dispersant composition or combinations thereof. The methods of making and using the linear polymer dispersant composition or the branched polymer dispersant composition are also provided.

### CROSS-REFERENCE TO RELATED APPLICATIONS

This application claims priority to and benefit of U.S. Provisional Patent Application No. 63/789,717, filed on Apr. 16, 2025, which is incorporated by reference in its entirety.

### FIELD OF THE INVENTION

The present invention relates to a polymer dispersant composition. The invention further relates to a linear polymer dispersant composition or a branched polymer dispersant composition. The present invention also relates to methods of making and using the polymer dispersant composition.

### BACKGROUND OF THE INVENTION

Clays are increasingly present in building materials. In concrete, clay can be added voluntarily to replace a part of cement in order to reduce the carbon footprint or it can be introduced involuntarily by the use of clay-bearing sands. In gypsum, good quality sources without clay are becoming depleted and panel manufacturers are forced to use lower quality gypsum.

Dispersants for hydraulic compositions are chemical admixtures, and used for dispersing binder particles, thereby reducing a unit water quantity necessary for achieving a required flowability and enhancing workability and the like of a hydraulic composition. There are conventionally known dispersants, including naphthalene-based dispersants such as a naphthalenesulfonic acid-formaldehyde condensate, polycarboxylic acid-based dispersants such as a comb-type copolymer of a carboxylic acid and a monomer having an alkylene glycol chain, melamine-based dispersants such as melaminesulfonic acid-formaldehyde condensate, and lignosulfonate-based dispersants.

Traditional dispersants for hydraulic binders have limitations. Polynaphthalene sulfonate-formaldehyde condensate (PNS) have the disadvantage of relatively low slump retention in cementitious compositions and have limited efficacy to reduce water in gypsum slurries. They also have limited compatibility with clays. Polycarboxylate ether (PCE) are highly sensitive to some types of clays and get adsorbed and entrapped when these are present in hydraulic binders.

When clays are present in hydraulic binders either naturally or voluntarily added, the dosage of traditional dispersants must be increased to achieve a desirable workability, which adds significant costs to the overall material composition. Increased dosage often leads to other problems such as reduced compressive strength.

Accordingly, a need exists for a robust dispersant for hydraulic binders demonstrating excellent performance in the presence of clays.

In light of the above, it would be desirable to develop a robust polymeric dispersant composition for hydraulic binders.

Therefore, it is a main object of the present invention to provide the linear polymer dispersant composition and the branched polymer dispersant composition.

It is an object of the present invention to provide the methods of preparing the linear polymer dispersant composition and the branched polymer dispersant composition.

It is also an object of the present invention to provide the methods of using the linear polymer dispersant composition and the branched polymer dispersant composition.

It is another object of the present invention to provide a robust dispersant for hydraulic binders.

It is still another object of the present invention to provide a robust dispersant for hydraulic binders that may contain clays.

It is also an object of the present invention to provide a dispersant that does not contain formaldehyde.

It is a further object of the present invention to provide a dispersant having compatibility with clays.

It is still another object of the present invention to provide a dispersant composition to adapt to the changing needs of the industry, that exhibit excellent performance, and is environmentally friendly and cost-effective.

These needs and other needs are met by the various aspects of the present disclosure.

### SUMMARY OF THE INVENTION

In accordance with the purpose(s) of this invention, as embodied and broadly described herein, this invention, in one aspect, relates to a polymer dispersant composition and methods of making and using the same.

In some embodiments, a polymer dispersant composition, can include a monomer A; a monomer B; a monomer C; and a solvent, wherein the polymer dispersant composition comprises a reaction product of the monomer A, the monomer B, and the monomer C, in the solvent, and wherein the sum of the mole % of the monomer A, the monomer B, and the monomer C being 100 moles %.

In other embodiments, a method of preparing a polymer dispersant composition, can include preparing a mixture of a monomer A, a monomer B, and a monomer C in a solvent in the presence of a chain transfer agent; preparing a mixture of an initiator in a solvent; polymerizing the mixture of the monomer A, the monomer B, the monomer C with the initiator in the solvent at an optimum temperature to prepare the polymer dispersant composition.

In certain embodiments, a method of using a polymer dispersant composition for a hydraulic binder, can include providing a hydraulic binder; adding an optional clay component to the hydraulic binder or the hydraulic binder has a clay component within the hydraulic binder; adding the polymer dispersant composition at a pH of about 2.5 to about 11 to the hydraulic binder; mixing the hydraulic binder, the optional clay component and the polymer dispersant composition together; and forming a stable dispersion, wherein the amount of dispersant is from about 0.1 wt. % to about 2 wt % of the total weight of the hydraulic binder.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION OF THE INVENTION

### I. Definitions

The following terms are intended to have the meanings presented therewith below and are useful in understanding the description and intended scope of the present invention.

The articles “a” and “an” may be used herein to refer to one or to more than one (i.e., at least one) of the grammatical objects of the article. By way of example “an analogue” means one analogue or more than one analogue.

The term “about” as used herein, refers that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments. Additionally, in phrase “about X to Y,” is the same as “about X to about Y,” that is the term “about” modifies both “X” and “Y.”

The term “compound” as used herein, refers to salts, complexes, isomers, stereoisomers, diastereoisomers, tautomers, and isotopes of the compound or any combination thereof.

The term “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are used in their inclusive, open-ended, and non-limiting sense.

The term “effective,” as that term is used in the specification and/or claims, means adequate to accomplish a desired, expected, or intended result.

The term “coating” refers to a coating in a form that is suitable for application to a substrate as well as the material after it is applied to the substrate, while it is being applied to the substrate, and both before and after any post-application treatments (such as evaporation, cross-linking, curing, and the like). The components of the coating compositions may vary during these stages.

The terms “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

The term “agglomerated” refers to a weak association of primary particles or aggregated particles usually held together by charge or polarity. Agglomerated particles can typically be broken down into smaller entities by, for example, shearing forces encountered during dispersion of the agglomerated particles in a liquid.

The terms “aggregated” and “aggregates” refer to a strong association of primary particles often bound together by, for example, residual chemical treatment, covalent chemical bonds, or ionic chemical bonds. Further breakdown of the aggregates into smaller entities is very difficult to achieve.

The term “dispersed” refers to the particles are dispersed in a medium such as a solvent containing a polymeric dispersant to form a substantially uniform dispersion of the particles throughout the medium without substantial agglomeration of the particles.

The term “dispersant” refers to a substance that is added to a suspension of solid or liquid particles in a liquid to stabilize the dispersed particles in a suspension, to improve the separation of the particles and to prevent their clumping.

The term “linear polymer” refers to a polymer consisting of a chain structure having one straight chain of many monomers' units.

The term “branched polymer” refers to a polymer consisting of a chain structure having one main chain of monomers units with smaller segments as branches of the main chain.

### II. Polymer Dispersant Composition

The inventors have surprisingly found that when at least 0.1 wt. % of polymer dispersant composition when added to hydraulic binder including cement or gypsum slurries containing clays, the dispersant exhibited improved performance in comparison to traditional dispersant. The invention provides a polymer dispersant composition and methods.

In some embodiments, a polymer dispersant composition, can include a monomer A; a monomer B; a monomer C; and a solvent, wherein the polymer dispersant composition comprises a reaction product of the monomer A, the monomer B, and the monomer C, in the solvent, and wherein the sum of the mole % of the monomer A, the monomer B, and the monomer C being 100 moles %.

In another embodiment, the polymer dispersant composition can include a linear polymer dispersant composition, a branched polymer dispersant composition or combinations thereof.

In certain embodiments, the monomer A can include 2-acrylamido-2-methyl-1-propanesulfonic acid (AMPS), styrenesulfonic acid, 3-sulfopropyl methacrylic acid, 2-(meth)acrylamide-2-methanesulfonic acid, 2-(meth)acrylamide-2-ethanesulfonic acid, vinyl sulfonic acid, 2-methacrylamido-2-methyl propyl sulfonic acid, allyl sulfonic acid, allyl sulfonic acid, 2-methyl-2-propene-1-sulfonic acid, 2-propene-1-sulfonic acid, (meth)allyl sulfonic acids, (meth)allyloxy benzene sulfonic acids, allyloxy hydroxyalkyl sulfonic acids, and salts or combinations thereof.

In other embodiments, the amount for monomer A ranges from about 0 moles % to about 70 moles %.

In certain embodiments, the monomer B can include acrylic acid, methacrylic acid, itaconic acid, ethacrylic acid, crotonic acid, maleic acid, fumaric acid, citraconic acid, sorbic acid, mesaconic acid, glutaconic acid, alpha-phenyl acrylic acid, beta-acyloxy propionic acid, angelic acid, cinnamic acid, vinyl acetic acid, allyl acetic acid, 4-methyl-4-pentenoic acid, acid anhydride and salts or combinations thereof.

In further embodiments, the amount for monomer B ranges from about 0 moles % to about 60 moles %.

In certain embodiments, the monomer C can include mono-hydroxyethyl methacrylate (HEMA) phosphate, di-hydroxyethyl methacrylate (HEMA) phosphate, hydroxypropyl methacrylate phosphate, hydroxy butyl methacrylate phosphate, hydroxyethyl acrylate phosphate, hydroxy ethyl-beta carboxy ethyl acrylate phosphate ester, vinyl phosphonic acid, allyl glycerol ether phosphate ester, allyl alcohol phosphate ester, and salts or combinations thereof. The preferred monomer C is hydroxyethyl methacrylate (HEMA) phosphate where monomer C may contain impurities such as residual hydroxyalkyl (meth)acrylate and residual phosphoric acid.

In other embodiments, the amount for monomer C ranges from about 1 mole % to about 35 moles %.

In certain embodiments, the composition of HEMA Phosphate (Monomer C) is shown in Table 1 below (expressed as relative proportions):

TABLE 1

| | Ideal Range | Broad Range | Broadest Range |
|---|---|---|---|
| Compound | (% moles) | (% moles) | (% moles) |
| Mono- | 50-90 | 42-95 | 35-100 |
| hydroxyethyl | | | |
| methacrylate | | | |
| phosphate | | | |
| Di-hydroxyethyl | 10-50 | 5-58 | 0-65 |
| methacrylate | | | |
| Phosphate | | | |

The esterification is made from 2-HEMA and polyphosphoric acid (PPA) 115%. PPA 115% can be replaced by PPA 105% or with a mixture of Phosphoric acid 85% and P₂O₅.

In some embodiments, the solvent can include water, ethanol, methanol, n-propanol, isopropanol, n-butanol, isobutanol, hexane, ethyl acetate, methyl ethyl ketone, diethyl ether, N-methyl-2-pyrrolidone (NMP), N,N-dimethylformamide (DMF), dimethyl sulfoxide (DMSO) or combinations thereof.

In other embodiments, the average molecular weight ranges from about 1000 g/mol to about 200,000 g/mol.

In another embodiment, the average molecular weight is determined by size exclusion chromatography.

In further embodiments, the average molecular weight is determined by ultracentrifugation on specialized filters method, osmotic pressure method, viscosity method, light scattering method or combinations thereof.

In certain embodiments, the polymer dispersant composition can further can include a monomer D.

In some embodiments, the monomer D can include hydroxyethyl methacrylate (HEMA), hydroxyethyl acrylate (HEA), acrylamide, methacrylamide, N-methyl (meth)acrylamide, N,N-dimethyl (meth)acrylamide, cationic monomers or combinations thereof.

### III. Methods of Making Polymer Dispersant Composition

The invention provides methods of making and using a polymer dispersant composition.

In some embodiments, a method of preparing a polymer dispersant composition, can include preparing a mixture of a monomer A, a monomer B, and a monomer C in a solvent in the presence of a chain transfer agent; preparing a mixture of an initiator in a solvent; polymerizing the mixture of the monomer A, the monomer B, the monomer C with the initiator in the solvent at an optimum temperature to prepare the polymer dispersant composition.

In other embodiments, the polymer dispersant composition can include a linear polymer dispersant composition, a branched polymer dispersant composition or combinations thereof.

In certain embodiments, the initiator is selected from the group consisting of hydrogen peroxide, persulphuric acid, 2,2′-azobis(2-methylpropionamidine dihydrochloride) dihydrate, azobisisobutyronitrile, sodium metabisulfite with sodium persulfate, sodium persulfate with iron sulfate, benzoyl peroxide, lauryl peroxide, azo compounds, peroxides, redox initiator systems or salt and mixtures thereof.

In other embodiments, the chain transfer agent is selected from the group consisting of 2-mercaptoethanol, 2-mercaptopropionic acid, 3-mercaptopropionic acid, thioglycerol, thioglycolic acid, halogenated hydrocarbons, disulfides, and mixtures thereof.

In further embodiments, the polymerization temperature ranges from about 30° C. to about 150° C.

In some embodiments, the solvent can include water, ethanol, methanol, n-propanol, isopropanol, n-butanol, isobutanol, hexane, ethyl acetate, methyl ethyl ketone, diethyl ether, N-methyl-2-pyrrolidone (NMP), N,N-dimethylformamide (DMF), dimethyl sulfoxide (DMSO) or combinations thereof.

In other embodiments, the average molecular weight ranges from about 1000 g/mol to about 200,000 g/mol.

### IV. Methods of Using Polymer Dispersant Composition

The invention provides methods of using a polymer dispersant composition.

In some embodiments, a method of using a polymer dispersant composition for a hydraulic binder, can include providing a hydraulic binder; adding an optional clay component to the hydraulic binder or the hydraulic binder has a clay component within the hydraulic binder; adding the polymer dispersant composition at a pH of about 2.5 to about 11 to the hydraulic binder; mixing the hydraulic binder, the optional clay component and the polymer dispersant composition together; and forming a stable dispersion, wherein the amount of dispersant is from about 0.1 wt. % to about 2 wt % of the total weight of the hydraulic binder.

In another embodiment, the polymer dispersant composition can include a linear polymer dispersant composition, a branched polymer dispersant composition or combinations thereof.

In other embodiments, the hydraulic binder can include Portland cement, natural cement, gypsum, blast furnace slag, limestone, fly ash, cement-based slurries, gypsum-based slurries, or combinations thereof.

In certain embodiments, the polymer dispersant composition is used alone or in combination with other dispersants.

In other embodiments, the other dispersants can include polynaphthalene sulfonate (PNS), lignosulfonate, polymelamine sulfonate (PMS), polycarboxylates, acetone-formaldehyde sulfonates, polyarylethers, polyaspartates, oligomeric dispersants or combinations thereof.

In some embodiments, the clay component can include a swelling clay, a non-swelling clay or combinations thereof.

In other embodiments, the swelling clay can include smectite clays, bentonite, montmorillonite, vermiculite with glauconite, attapulgite clays or combinations thereof.

In certain embodiments, the non-swelling clay can include kaolinite clay, kaolin, metakaolin, halloysite, illite, nacrite, dickite, glauconite, authigenic, diagenetic, chlorite clinochlore, chamosite, palygorskite polymorph, hydrated form, or combinations thereof.

In further embodiments, the polymer dispersant composition is used in concrete, gypsum or gypsum-based materials, agriculture, lubricants, pigments, waxes, resin collectors, batteries, carbon, graphene, inks, paints, plastic, coatings, emulsification, nanoparticles, nanocomposites, mining or combinations thereof.

### EXAMPLES

The following examples are illustrative, but not limiting, of the methods and compositions of the present disclosure. Other suitable modifications and adaptations of the variety of conditions and parameters normally encountered in the field, and which are obvious to those skilled in the art, are within the spirit and scope of the disclosure. All patents and publications cited herein are fully incorporated by reference herein in their entirety.

### Example 1: Preparation of Polymer Dispersant Composition (Method A)

### Preparation of the Monomers Mixture:

2-Acrylamido-2-methyl-1-propanesulfonic acid, sodium salt (AMPS) (115.5 g, 50%), methacrylic acid (9.6 g), 2-hydroxyethyl methacrylate (HEMA) phosphate (35.4 g) and water (5.9 g) were added in this order and stirred. The reaction mixture was stirred for 15 minutes for proper mixing. Sodium hydroxide (5 g, 50%) was added over a period of 15-minutes followed by the addition of 2-mercaptoethanol (1.0 g) over a period of 15-minutes. The reaction mixture was further stirred for 10 minutes to homogenize the monomers mixture.

### Preparation of Initiator Mixture:

Sodium persulfate (1.6 g) and water (14.3 g) were mixed. The reaction mixture was stirred for 15 minutes to ensure complete dissolution of the initiator.

### Polymerization to Isolate Polymer Dispersant Composition:

The monomers mixture (3.3 g) and water (37.6 g) were stirred and the temperature was raised to 90° C. The monomers mixture and initiator mixture were then fed to the reactor simultaneously. The monomers mixture was fed to the reactor over 4 hours and initiator mixture was fed to the reactor over 5 hours. The temperature was maintained at 90° C. for 1 hour. The temperature of the reaction mixture was reduced to 80° C. Hydrogen peroxide (0.6 g, 50%) was then added over a period of 30 minutes. The temperature was maintained at 80° C. for 30 minutes. The temperature of the reaction mixture was further reduced to 70° C. and neutralized with sodium hydroxide (50%). The reaction mixture was diluted to the desired % solids to obtain polymer dispersant composition.

### Example 2: Preparation of Polymer Dispersant Composition (Method B)

Preparation of the monomers mixture: 2-Acrylamido-2-methyl-1-propanesulfonic acid, sodium salt (AMPS) (111.1 g, 50%), methacrylic acid (20.9 g), 2-hydroxyethyl methacrylate (HEMA) phosphate (3.4 g) and water (5.6 g) were added in this order and stirred. The reaction mixture was stirred for 15 minutes for proper mixing. Sodium hydroxide (0.4 g, 50%) was added over a period of 15-minutes followed by the addition of 2-mercaptoethanol (1.0 g) over a period of 15-minutes. The reaction mixture was further stirred for 10 minutes to homogenize the monomers mixture.

### Preparation of Initiator Mixture:

Sodium persulfate (1.1 g) and water (9.6 g) were mixed. The reaction mixture was stirred for 15 minutes to ensure complete dissolution of the initiator.

### Polymerization to Isolate Polymer Dispersant Composition:

The monomers mixture (4.6 g) and water (49 g) were stirred and the temperature was raised to 90° C. The monomers mixture and initiator mixture were then fed to the reactor simultaneously. The monomers mixture was fed to the reactor over 4 hours and initiator mixture was fed to the reactor over 5 hours. The temperature was maintained at 90° C. for 1 hour. The temperature of the reaction mixture was reduced to 80° C. Hydrogen peroxide (0.4 g, 50%) was then added over a period of 30 minutes. The temperature was maintained at 80° C. for 30 minutes. The temperature of the reaction mixture was further reduced to 70° C. and neutralized with sodium hydroxide (50%). The reaction mixture was diluted to the desired % solids to obtain polymer dispersant composition.

### Example 3: Preparation of Polymer Dispersant Composition (Method C)

### Preparation of the Monomers Mixture:

2-Acrylamido-2-methyl-1-propanesulfonic acid, sodium salt (AMPS) (115.5 g, 50%), itaconic acid (28.8 g), 2-hydroxyethyl methacrylate (HEMA) phosphate (10.7 g) and water (5.9 g) were added in this order and stirred. The reaction mixture was stirred for 15 minutes for proper mixing. Sodium hydroxide (1.4 g, 50%) was added over a period of 15-minutes followed by the addition of 2-mercaptoethanol (1.4 g) over a period of 15-minutes. The reaction mixture was further stirred for 10 minutes to homogenize the monomers mixture.

### Preparation of Initiator Mixture:

Sodium persulfate (1.6 g) and water (14.3 g) were mixed. The reaction mixture was stirred for 15 minutes to ensure complete dissolution of the initiator.

### Polymerization to Isolate Polymer Dispersant Composition:

The monomers mixture (4.5 g) and water (52.4 g) were stirred and the temperature was raised to 90° C. The monomers mixture and initiator mixture were then fed to the reactor simultaneously. The monomers mixture was fed to the reactor over 4 hours and initiator mixture was fed to the reactor over 5 hours. The temperature was maintained at 90° C. for 1 hour. The temperature of the reaction mixture was reduced to 80° C. Hydrogen peroxide (0.6 g, 50%) was then added over a period of 30 minutes. The temperature was maintained at 80° C. for 30 minutes. The temperature of the reaction mixture was further reduced to 70° C. and neutralized with sodium hydroxide (50%). The reaction mixture was diluted to the desired % solids to obtain polymer dispersant composition.

### Example 4: Preparation of Polymer Dispersant Composition (Method D)

### Preparation of the Monomers Mixture:

2-Acrylamido-2-methyl-1-propanesulfonic acid, sodium salt (AMPS) (111.1 g, 50%), methacrylic acid (20.9 g), 2-hydroxyethyl methacrylate (HEMA) phosphate (3.4 g) and water (5.6 g) were added in this order and stirred. The reaction mixture was stirred for 15 minutes for proper mixing. Sodium hydroxide (0.4 g, 50%) was added over a period of 15-minutes followed by the addition of 2-mercaptoethanol (1.0 g) over a period of 15-minutes. The reaction mixture was further stirred for 10 minutes to homogenize the monomers mixture.

### Preparation of Initiator Mixture:

Sodium persulfate (1.1 g) and water (9.6 g) were mixed. The reaction mixture was stirred for 15 minutes to ensure complete dissolution of the initiator.

### Polymerization to Isolate Polymer Dispersant Composition:

The monomers mixture (4.6 g), water (21.7 g) and isopropanol (17.0 g) were stirred and the temperature was raised to 90° C. The monomers mixture and initiator mixture were then fed to the reactor simultaneously. The monomers mixture was fed to the reactor over 4 hours and initiator mixture was fed to the reactor over 5 hours. The temperature was maintained at 90° C. for 1 hour. The temperature of the reaction mixture was reduced to 80° C. Hydrogen peroxide (0.4 g, 50%) was then added over a period of 30 minutes. The temperature was maintained at 80° C. for 30 minutes. The temperature of the reaction mixture was further reduced to 70° C. and neutralized with sodium hydroxide (50%). The reaction mixture was diluted to the desired % solids to obtain polymer dispersant composition.

### Linear Polycarboxylate (LPC) Characterization and Properties

### LPC on Concrete Equivalent Mortar (CEM) Containing Clays

LPC on concrete with clays is shown in Table 2 below:

TABLE 2

| | | Ideal Range | | |
|---|---|---|---|---|
| | | for good | | |
| | Ideal | maintenance | | |
| | Range for | of | Broad | Broadest |
| | low dosage | spreading | Range | Range |
| Monomer | (% moles) | (% moles) | (% moles) | (% moles) |
| AMPS, Na salt | 38-50 | 54-57 | 31-70 | 0-70 |
| MA | 40-47 | 42-48 | 0-60 | 0-60 |
| HEMA Phosphate | 6-15 | 1-3 | 1-35 | 1-35 |

Ratio of monomer of LPC use on Cement slurries/CEM with clays

In the case of 0% methacrylic acid, it is required to add a defoamer to the slurry.

Following are performances on concrete mortar equivalent (CEM) containing 3% bentonite (weight % to binder) of two LPC (Different monomer ratio and molecular weight) is shown in Table 3 below:

TABLE 3

| | | Slump | Slump | Slump | |
|---|---|---|---|---|---|
| | | retention | retention | retention | |
| | Dosage | at 30/10 | at 60/10 | at 90/10 | |
| Dispersing | kg/m3 | minutes | minutes | minutes | Setting |
| Agent | CEM | (%) | (%) | (%) | time |
| PNS, sodium | 14.0 | 102 | 99 | 97 | 10 h 31 |
| salt | | | | | |
| Robust | 5.5 | 82 | 68 | 62 | 14 h 51 |
| dispersant V1 | | | | | |
| Robust | 5.2 | 92 | 85 | 79 | 14 h 30 |
| dispersant V2 | | | | | |
| 20% Robust | 9.9 | 99 | 97 | 98 | 12 h 34 |
| dispersant V1/ | | | | | |
| 80% PNS, | | | | | |
| sodium salt | | | | | |
| 20% Robust | 9.7 | 99 | 104 | 97 | 11 h 37 |
| dispersant V2/ | | | | | |
| 80% PNS, | | | | | |
| sodium salt | | | | | |

Water to cement ratio: 0.38; Cement: Lafarge GUL 2023

LPC on Concrete Equivalent Mortar (CEM) without Clays

LPC on concrete without clays is shown in Table 4 below:

TABLE 4

| | | Ideal Range | | |
|---|---|---|---|---|
| | Ideal | for good | | |
| | Range for | maintenance | Broad | Broadest |
| | low dosage | of spreading | Range | Range |
| Monomer | (% moles) | (% moles) | (% moles) | (% moles) |
| AMPS, Na salt | 30-50 | 55-59 | 31-60 | 0-70 |
| MA | 40-60 | 40-45 | 21-60 | 0-60 |
| HEMA Phosphate | 6-12 | 1-3 | 1-12 | 1-35 |

Ratio of monomer of LPC use on Cement slurries/CEM without clays

For dispersing cement-based slurries (with and without clays) a pH of 2.5-11 can be use, preferably a pH of 3-8, and more preferably a pH of 3-5.

### Linear PC on Gypsum Containing Clays

LPC on gypsum with clays is shown in Table 5 below:

TABLE 5

| | Ideal Range, | Ideal Range, | Broad | Broadest |
|---|---|---|---|---|
| | Option 1 | Option 2 | Range | Range |
| Monomer | (% mole) | (% mole) | (% mole) | (% mole) |
| AMPS, Na salt | 47-53 | 62-68 | 31-70 | 0-70 |
| MA | 42-46 | 0-5 | 0-60 | 0-60 |
| HEMA | 5-12 | 30-37 | 9-35 | 1-35 |
| Phosphate | | | | |

Ratio of monomer of LPC use on gypsum-based slurries with clay

For ideal range, there is two different options. While testing the limits of ratios, it was discovered that two possible range gives best performances. Between that, the performance is less. The ratios in between are included in the Broad Range of monomers.

Performances on gypsum slurry containing 3% bentonite (weight % to binder) of one LPC are shown in Table 6a and 6b below:

TABLE 6a

| | Dispersant | | |
|---|---|---|---|
| | Dosage | Spread | |
| Dispersing Agent | (%) | (mm) | Stiffening Time |
| PNS, Na salt | 1.85 | 78 | 0:01:55 |
| PNS, Na salt + 20% LPC | 0.66 | 78 | 0:04:20 |

Gypsum: Georgia Pacific Sweetwater, sifted. Water reduction ratio: 20%.

TABLE 6b

| | Water | Dispersant | | |
|---|---|---|---|---|
| | reduction | Dosage | Spead | Stiffening |
| Dispersant | (%) | (%) | (mm) | time |
| PNS, Na salt | 10 | 0.350 | 78 | 00:02:00 |
| | 20 | 1.750 | 80 | 00:02:00 |
| | 30 | 6.750 | 82 | 00:01:50 |
| 90% PNS Na salt + | 10 | 0.350 | 78 | 00:02:00 |
| 10% LPC | 20 | 1.400 | 81 | 00:03:35 |
| | 30 | 4.000 | 80 | 00:09:35 |
| 80% PNS Na salt + | 10 | 0.350 | 80 | 00:02:00 |
| 20% LPC | 20 | 1.000 | 81 | 00:04:30 |
| | 30 | 2.750 | 80 | 00:12:30 |
| LPC | 10 | 0.180 | 79 | 00:02:55 |
| | 20 | 0.555 | 82 | 00:12:45 |
| | 30 | 1.150 | 81 | 00:33:30 |
| PCE | 10 | 0.650 | 79 | 00:02:00 |
| | 20 | 1.500 | 81 | 00:14:00 |
| | 30 | 3.500 | 80 | 00:40:00 |

Gypsum: Certainteed Ste-Catherine, sifted, tested at various water reduction ratios

Linear PC on Gypsum without Clays

LPC on gypsum without clays is shown in Table 7 below:

TABLE 7

| | Ideal Range, | Ideal Range, | Broad | Broadest |
|---|---|---|---|---|
| | Option 1 | Option 2 | Range | Range |
| Monomer | (% mole) | (% mole) | (% mole) | (% mole) |
| AMPS, Na salt | 47-53 | 62-68 | 31-70 | 0-70 |
| MA | 42-46 | 0-5 | 0-60 | 0-60 |
| HEMA | 5-12 | 30-37 | 6-35 | 1-35 |
| Phosphate | | | | |

Ratio of monomer of LPC use on gypsum-based slurries

Performances on gypsum slurry without clay of one LPC are shown in Table 8 below:

TABLE 8

| | Water | Dispersant | | |
|---|---|---|---|---|
| | reduction | Dosage | Spead | Stiffening |
| Dispersant | (%) | (%) | (mm) | time |
| PNS Na salt | 10 | 0.400 | 82 | 00:02:00 |
| | 20 | 1.500 | 79 | 00:02:00 |
| | 30 | 4.250 | 80 | 00:02:00 |
| 90% PNS Na salt + | 10 | 0.300 | 80 | 00:02:00 |
| 10% LPC | 20 | 1.200 | 80 | 00:03:15 |
| | 30 | 2.250 | 81 | 00:05:45 |
| 80% PNS Na salt + | 10 | 0.400 | 80 | 00:02:00 |
| 20% LPC | 20 | 1.000 | 80 | 00:04:25 |
| | 30 | 1.750 | 81 | 00:09:00 |
| LPC | 10 | 0.160 | 80 | 00:02:45 |
| | 20 | 0.500 | 80 | 00:14:20 |
| | 30 | 0.750 | 78 | 00:30:00 |
| PCE | 10 | 0.150 | 83 | 00:02:00 |
| | 20 | 0.225 | 78 | 00:02:45 |
| | 30 | 0.500 | 79 | 00:05:05 |

Gypsum: Certainteed Ste-Catherine, sifted, tested at various water reduction ratios

For dispersing gypsum-based slurries (with and without clays) a pH of 4-11.5 can be use, preferably a pH of 6-10, and more preferably a pH of 8-10.

Applicable to every hydraulic binder, the molecular weight of the linear polymer dispersant ranges from about 1000 to about 200,000 g/mol, preferably, from about 2000 to about 100,000 g/mol and more preferably, from about 3000 to about 40,000 g/mol. The molecular weight is determined with the following protocol.

### Size Exclusion Chromatography-Protocol:

The molecular weight (Mₙ, M_{w}) was determined via size exclusion chromatography (SEC). A PCL solution with a concentration of 2.5 g/L was prepared. The filtered (0.45 μm) sample was separated in an Agilent 1260 separation module by particle size with two PSS-MCX columns (1000, 100 000 Å) and a PSS-MCX guard column (Polymer Standards Service USA-inc, Amherst, United States). The prepared sample solution was pumped (flow rate=0.69 mL/min) through the system with a 0.025 N NaNO₃ solution containing 5% (v/v) of acetonitrile. The refractive index detector (1260 Infinity II RID, Agilent, California, United States) allowed the characterization. The absolute molar masses were calculated based on the known molar masses of a Poly(styrene sulfonate) sodium salt standards kits (β-NSA, 2k-450K) (Polymer Standards Service USA-inc, Amherst, United States). The data collection and evaluation were carried out via the software program OpenLab (Agilent, California, United States).

### Gypsum Test Method:

The water demand of gypsum slurries without dispersant was determined by mixing gypsum and clays to obtain a homogeneous powder. Water was added and the slurry was mixed in a circular motion with a stem for one minute. The slurry was then poured into a 30×50 mm (diameter×height) metal cylinder and let to spread after lifting the cylinder. The water demand was adjusted in order to obtain a slurry spread of 80+/−2 mm. The setting time are reported for all tests.

The dispersant demand of gypsum slurries was determined by mixing gypsum and clay to obtain a homogeneous powder. The tests were carried out at various water reduction ratios. The dispersant was mixed with water to obtain a homogenous solution. Water solution was added, and the slurry was mixed in a circular motion with a stem for one minute. The slurry was then poured into a 30×50 mm (diameter×height) metal cylinder and let to spread after lifting the cylinder. The dispersant dosage was adjusted in order to obtain a slurry spread of 80+/−2 mm. The stiffening time is reported for all tests.

### Concrete Equivalent Mortar (CEM) Test Method:

This method consists of taking spread measurements on a mortar formulation whose rheological properties are correlated with those of concrete, by following a defined mixing procedure to ensure equivalency and repeatability of the tests. The method consists of filling a slump cone whose dimensions meet the CSA A23.2-5C standard. The slump test then involves lifting the cone to measure the spread of the mortar by gravity. The measurements are taken after 10, 30, 60 and 90 minutes after the end of mortar mixing to assess the rheological profile over time. The results are reported as ratios over time. The setting time of the concrete equivalent mortar mixtures is determined using a semi-adiabatic calorimeter.

### INDUSTRIAL APPLICATIONS

The present invention provides a robust linear or branched polymer dispersant composition for hydraulic binders demonstrating improved performance in the presence of clays. The hydraulic binders, include but not limited to, cement or gypsum. The present invention provides the methods of preparing the linear or branched polymer dispersant composition and the methods of using the linear or branched polymer dispersant composition. The present invention provides a polymer-based dispersant that does not contain formaldehyde. The present invention also provides a dispersant composition that can adapt to the changing needs of the industry, is environmentally friendly and cost-effective. The linear or branched polymer dispersant composition of the present invention offers several industrial applications, including but not limited to, in concrete, gypsum or gypsum-based materials, agriculture, lubricants, pigments, waxes, resin collectors, batteries, carbon, graphene, inks, paints, plastic, coatings, emulsification, nanoparticles, nanocomposites, mining or combinations thereof.

While in the foregoing specification this invention has been described in relation to certain embodiments thereof, and many details have been put forth for the purpose of illustration, it will be apparent to those skilled in the art that the invention includes additional embodiments and that certain of the details described herein can be varied considerably without departing from the basic principles of the invention. Although we have described the preferred embodiments for implementing our invention, it will be understood by those skilled in the art to which this disclosure is directed that modifications and additions may be made to our invention without departing from its scope.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

What is claimed is:

1. A polymer dispersant composition, comprising:
a monomer A;
a monomer B;
a monomer C; and
a solvent,
wherein the polymer dispersant composition comprises a reaction product of the monomer A, the monomer B, and the monomer C, in the solvent, and
wherein the sum of the mole % of the monomer A, the monomer B, and the monomer C being 100 moles %.

2. The polymer dispersant composition of claim 1, wherein the polymer dispersant composition comprises a linear polymer dispersant composition, a branched polymer dispersant composition or combinations thereof.

3. The polymer dispersant composition of claim 1, wherein the monomer A comprises 2-acrylamido-2-methyl-1-propanesulfonic acid (AMPS), styrenesulfonic acid, 3-sulfopropyl methacrylic acid, 2-(meth)acrylamide-2-methanesulfonic acid, 2-(meth)acrylamide-2-ethanesulfonic acid, vinyl sulfonic acid, 2-methacrylamido-2-methyl propyl sulfonic acid, allyl sulfonic acid, allyl sulfonic acid, 2-methyl-2-propene-1-sulfonic acid, 2-propene-1-sulfonic acid, (meth)allyl sulfonic acids, (meth)allyloxy benzene sulfonic acids, allyloxy hydroxyalkyl sulfonic acids, and salts or combinations thereof.

4. The polymer dispersant composition of claim 1, wherein the amount for monomer A ranges from about 0 moles % to about 70 moles %.

5. The polymer dispersant composition of claim 1, wherein the monomer B comprises acrylic acid, methacrylic acid, itaconic acid, ethacrylic acid, crotonic acid, maleic acid, fumaric acid, citraconic acid, sorbic acid, mesaconic acid, glutaconic acid, alpha-phenyl acrylic acid, beta-acyloxy propionic acid, angelic acid, cinnamic acid, vinyl acetic acid, allyl acetic acid, 4-methyl-4-pentenoic acid, acid anhydride and salts or combinations thereof.

6. The polymer dispersant composition of claim 1, wherein the amount for monomer B ranges from about 0 moles % to about 60 moles %.

7. The polymer dispersant composition of claim 1, wherein the monomer C comprises mono-hydroxyethyl methacrylate (HEMA) phosphate, di-hydroxyethyl methacrylate (HEMA) phosphate, hydroxypropyl methacrylate phosphate, hydroxy butyl methacrylate phosphate, hydroxyethyl acrylate phosphate, hydroxy ethyl-beta carboxy ethyl acrylate phosphate ester, vinyl phosphonic acid, allyl glycerol ether phosphate ester, allyl alcohol phosphate ester, and salts or combinations thereof. The preferred monomer C is hydroxyethyl methacrylate (HEMA) Phosphate where monomer C may contain impurities such as residual HEMA and residual phosphoric acid

8. The polymer dispersant composition of claim 1, wherein the amount for monomer C ranges from about 1 mole % to about 35 moles %.

9. The polymer dispersant composition of claim 1, wherein the solvent comprises water, ethanol, methanol, n-propanol, isopropanol, n-butanol, isobutanol, hexane, ethyl acetate, methyl ethyl ketone, diethyl ether, N-methyl-2-pyrrolidone (NMP), N,N-dimethylformamide (DMF), dimethyl sulfoxide (DMSO) or combinations thereof.

10. The polymer dispersant composition of claim 1, wherein the average molecular weight ranges from about 1000 g/mol to about 200,000 g/mol.

11. The polymer dispersant composition of claim 1, further comprising a monomer D.

12. The polymer dispersant composition of claim 11, wherein the monomer D comprises hydroxyethyl methacrylate (HEMA), hydroxyethyl acrylate (HEA), acrylamide, methacrylamide, N-methyl (meth)acrylamide, N,N-dimethyl (meth)acrylamide, cationic monomers or combinations thereof.

13. A method of preparing a polymer dispersant composition, comprising:
preparing a mixture of a monomer A, a monomer B, and a monomer C in a solvent in the presence of a chain transfer agent;
preparing a mixture of an initiator in a solvent;
polymerizing the mixture of the monomer A, the monomer B, the monomer C with the initiator in the solvent at an optimum temperature to prepare the polymer dispersant composition.

14. The method of 13, wherein the polymer dispersant composition comprises a linear polymer dispersant composition, a branched polymer dispersant composition or combinations thereof.

15. The method of 13, wherein the initiator is selected from the group consisting of hydrogen peroxide, persulphuric acid, 2,2′-azobis(2-methylpropionamidine dihydrochloride) dihydrate, azobisisobutyronitrile, sodium metabisulfite with sodium persulfate, sodium persulfate with iron sulfate, benzoyl peroxide, lauryl peroxide, azo compounds, peroxides, redox initiator systems or salt and mixtures thereof.

16. The method of 13, wherein the chain transfer agent is selected from the group consisting of 2-mercaptoethanol, 2-mercaptopropionic acid, 3-mercaptopropionic acid, thioglycerol, thioglycolic acid, halogenated hydrocarbons, disulfides, and mixtures thereof.

17. The method of 13, wherein the polymerization temperature ranges from about 30° C. to about 150° C.

18. The method of 13, wherein the solvent comprises water, ethanol, methanol, n-propanol, isopropanol, n-butanol, isobutanol, hexane, ethyl acetate, methyl ethyl ketone, diethyl ether, N-methyl-2-pyrrolidone (NMP), N,N-dimethylformamide (DMF), dimethyl sulfoxide (DMSO) or combinations thereof.

19. The method of 13, wherein the average molecular weight ranges from about 1000 g/mol to about 200,000 g/mol.

20. A method of using a polymer dispersant composition for a hydraulic binder, comprising:
providing a hydraulic binder;
adding an optional clay component to the hydraulic binder or the hydraulic binder has a clay component within the hydraulic binder;
adding the polymer dispersant composition at a pH of about 2.5 to about 11 to the hydraulic binder;
mixing the hydraulic binder, the optional clay component and the polymer dispersant composition together; and
forming a stable dispersion,
wherein the amount of dispersant is from about 0.1 wt. % to about 2 wt % of the total weight of the hydraulic binder.

21. The method of 20, wherein the polymer dispersant composition comprises a linear polymer dispersant composition, a branched polymer dispersant composition or combinations thereof.

22. The method of 20, wherein the hydraulic binder comprises Portland cement, natural cement, gypsum, blast furnace slag, limestone, fly ash, cement-based slurries, gypsum-based slurries, or combinations thereof.

23. The method of 20, wherein the polymer dispersant composition is used alone or in combination with other dispersants.

24. The method of 23, wherein the other dispersants comprise polynaphthalene sulfonate (PNS), lignosulfonate, polymelamine sulfonate (PMS), polycarboxylates, acetone-formaldehyde sulfonates, polyarylethers, polyaspartates, oligomeric dispersants or combinations thereof.

25. The method of 20, wherein the clay component comprises a swelling clay, a non-swelling clay or combinations thereof.

26. The method of 25, wherein the swelling clay comprises smectite clays, bentonite, montmorillonite, vermiculite with glauconite, attapulgite clays or combinations thereof.

27. The method of 25, wherein the non-swelling clay comprises kaolinite clay, kaolin, metakaolin, halloysite, illite, nacrite, dickite, glauconite, authigenic, diagenetic, chlorite clinochlore, chamosite, palygorskite polymorph, hydrated form, or combinations thereof.

28. The method of 20, wherein the polymer dispersant composition is used in concrete, gypsum or gypsum-based materials, agriculture, lubricants, pigments, waxes, resin collectors, batteries, carbon, graphene, inks, paints, plastic, coatings, emulsification, nanoparticles, nanocomposites, mining or combinations thereof.
